(19) United States
(12) Patent Application Publication
(10) Pub. No.: US 2026/0205434 A1
(43) Pub. Date: Jul. 16, 2026

(54) MANAGEMENT OF INSTANT MESSAGES AND EMAILS EXCHANGED BETWEEN USERS

(71) Applicant: Blix Inc., Newark, DE (US)

(72) Inventor: Ben VOLACH, Haifa (IL)

(73) Assignee: Blix Inc., Newark, DE (US)

(21) Appl. No.: 19/447,041

(22) Filed: Jan. 13, 2026

Related U.S. Application Data
(60) Provisional application No. 63/744,436, filed on Jan. 13, 2025.

(51) Int. Cl. H04L 51/56; H04L 51/04

(52) U.S. Cl. CPC H04L 51/56; H04L 51/04

(57) ABSTRACT

There is provided a system for enabling message transmission between registered user registered posting on a multi-user instant messaging (IM) session and to non-registered users via email, comprising: at least one processor of a server executing a code for: receiving a message posted to an interactive multi-user IM session by a first registered user, the message destined for at least one recipient, for each respective recipient, checking whether the respective recipient is a registered or non-registered, and in response to the respective recipient being non-registered, converting the message to an email, and sending the email to an email address of each respective recipient.

RELATED APPLICATION(S)

This application claims the benefit of priority under 35 USC §119(e) of U.S. Provisional Patent Application No. 63/744,436 filed on January 13, 2025, the contents of which are all incorporated by reference as if fully set forth herein in their entirety.

### BACKGROUND

The present invention, in some embodiments thereof, relates to managing of messages and, more specifically, but not exclusively, to management of instant messages and emails exchanged between users.

Users can choose from different types of messages in order to communicate with one or more others users. For example, a user may send an email to one or more other users. Each user receiving the email may reply to the original sender, and may include the other users who received the email as destination for the reply email. In another example, multiple users may participate in an instant message (IM) session, where each user is able to post a message to an interface that is synchronized amongst the other users. Users are able to post messages and view responses in real time.

### SUMMARY

According to a first aspect, a system for enabling message transmission between registered user registered posting on a multi-user instant messaging (IM) session and to non-registered users via email, comprises: at least one processor of a server executing a code for: receiving a message posted to an interactive multi-user IM session by a first registered user, the message destined for at least one recipient, for each respective recipient, checking whether the respective recipient is a registered or non-registered, and in response to the respective recipient being non-registered, converting the message to an email, and sending the email to an email address of each respective recipient.

In a further implementation form of the first aspect, further comprising: wherein the at least one recipient comprises at least one second registered user participating in the interactive multi-user IM session, and sending the message to a respective client terminal of each of the at least one second registered user for posting to the interactive multi-user IM session presented on a display of the respective client terminal of the respective second registered user.

In a further implementation form of the first aspect, wherein the email is sent to an email of a non-registered user, wherein a reply email is sent by the non-registered user to the first registered user as a response to the email, further comprising: accessing the reply email from an email account of the first registered user, and posting the reply email to the interactive multi-user IM session.

In a further implementation form of the first aspect, the first registered user and at least one second registered user are participating in the interactive multi-user IM session, and the reply email when posted to the interactive multi-user IM session is synchronized between, and presented on, a display of a client terminal of each one of the first registered user and the at least one second registered user.

In a further implementation form of the first aspect, further comprising deleting the reply email from the email account of the first registered user after obtaining the reply email from the email account.

In a further implementation form of the first aspect, the received reply email and the posting is one of: obtained by the at least one processor of the server from the email account of the first registered user and posted by the at least one processor of the server, and obtained by code running on a client terminal of the first registered user and posted to the interactive multi-user IM session by the code running on the client terminal of the registered user.

In a further implementation form of the first aspect, the reply email is posted to the interactive multi-user IM session as a continuation to a conversation between a plurality of users including the first registered user and the first non-registered user.

In a further implementation form of the first aspect, wherein the email is sent to an email account of a first non-registered user, wherein a reply email is sent by the first non-registered user to the first registered user as a response to the email, wherein the first non-registered user registers to become a second registered user participating in the interactive multi-user IM session, and wherein the reply email is obtained from the email account of the first registered user, posting the reply email to the interactive multi-user IM session to create an updated interactive multi-user IM session, and presenting an updated interactive multi-user IM session including the posted message obtained from the reply email, on a display of a client terminal of the second registered user participating in the interactive multi-user IM session.

In a further implementation form of the first aspect, the email is further sent to an email account of a second non-registered user, wherein the second non-registered user sends a reply email to an email account of the first registered user and to the email account of the first non-registered user, wherein the reply email is obtained from the email account of the first non-registered user that converted to become the second registered user by code running on a client terminal of the second registered user, and further comprising: receiving the reply email from the client terminal of the second registered user, and posting the reply email to the interactive multi-user IM session.

In a further implementation form of the first aspect, further comprising: receiving a query from the client terminal of the second registered user checking whether the reply email has been previously posted to the interactive multi-user IM session from the email account of the first registered user, and in response to an indication that the reply email has not been posted to the interactive multi-user IM session, receiving the reply email from the client terminal of the second registered user and posting the reply email to the interactive multi-user IM session.

In a further implementation form of the first aspect, further comprising: in response to an indication that the reply email has been posted to the interactive multi-user IM session from the email account of the first registered user, ignoring the reply email from the client terminal of the second registered user, and presenting the interactive multi-user IM session with the posted reply email on the display of the client terminal of the second registered user.

In a further implementation form of the first aspect, the second non-registered user registers to become the second registered user after the email is sent to the email address of the second non-registered user.

In a further implementation form of the first aspect, the registered user is registered for sending messages to other registered users via the multi-user IM session, and a non-registered user is not registered for sending messages via the multi-user IM session.

According to a second aspect, a system for enabling message transmission between registered user registered posting on a multi-user instant messaging (IM) session and to non-registered users via email, comprises: at least one processor of a server executing a code for: accessing a conversation between a plurality of registered users interacting in an interactive multi-user IM session, segmenting the conversation into a plurality of segmented conversation blocks, analyzing each of the plurality of segmented conversation blocks, according to the analysis, allocating each segmented conversation block of the plurality of segmented conversation blocks into cluster of a plurality of clusters, generating at least one email, each email corresponding to each cluster, each email including an aggregation of the segmented conversation blocks allocated to the cluster, and sending the at least one email to at least one non-registered user excluded from the interactive multi-user IM session.

In a further implementation form of the second aspect, the analyzing and the allocating comprises: dynamically clustering the segmented conversation blocks into the plurality of clusters using a transformer architecture and/or hybrid supervised-unsupervised processes.

In a further implementation form of the second aspect, the analyzing comprising: feeding each segmented conversation block of the plurality of segmented conversation blocks into a machine learning model, obtaining a classification category of a plurality of classification categories for each segmented messages from the machine learning model, allocating each segmented conversation block to a respective cluster corresponding to the classification category, wherein the email is generated for each cluster.

In a further implementation form of the second aspect, the analyzing comprises: clustering the plurality of segmented conversation blocks into a plurality of clusters using a clustering machine learning model using a non-supervised approach.

In a further implementation form of the second aspect, each cluster corresponds to a certain topic of a plurality of topics.

In a further implementation form of the second aspect, further comprising generating a conversation block for each cluster, and distributing a plurality of conversation blocks corresponding to the plurality of clusters to the plurality of registered users of the interactive multi-user IM session.

In a further implementation form of the second aspect, the plurality of conversation blocks are distributed as cluster-specific threads.

In a further implementation form of the second aspect, the at least one email includes a tag of the cluster in a subject field, and the plurality of registered users in the from and/or cc field.

In a further implementation form of the second aspect, further comprising: receiving in response to the at least one email, a reply email from the at least one non-registered user, uploading a reply message from the reply email to the corresponding cluster of the interactive multi-user IM session for viewing by the plurality of registered users, by synchronizing and distributing the reply message to the corresponding cluster provided to each of the plurality of registered users.

In a further implementation form of the second aspect, receiving the reply email comprises accessing the reply email from an email account of the at least one non-registered user, and deleting the reply email from the email account of the at least one non-registered user.

In a further implementation form of the second aspect, the receiving, the deleting, and the uploading, are performed by client code running on a device of a registered use of the plurality of registered users participating in the interactive multi-user IM session.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for managing a conversation between users exchanging IM and email messages, in accordance with some embodiments of the present invention;

FIG. 2A is a flowchart of a method of enabling message transmission between a registered user registered posting on a multi-user IM session and to non-registered users via email, in accordance with some embodiments of the present invention;

FIG. 2B is a flowchart of a method of enabling message transmission between a registered user registered and non-registered users where a non-registered user becomes a registered user, in accordance with some embodiments of the present invention;

FIG. 3 is a flowchart of a method for enabling message transmission between registered users registered posting on a multi-user instant messaging (IM) session and non-registered users via email based on clustering of conversation blocks into clusters, in accordance with some embodiments of the present invention;

FIG. 4 is a sequence diagram for enabling a conversation between registered and non-registered users via IM and email, in accordance with some embodiments of the present invention;

FIG. 5 is a sequence diagram for enabling a conversation between via IM and email where a NRU becomes a RU, in accordance with some embodiments of the present invention;

FIG. 6 is a sequence diagram for creating emails and/or threads based on clusters generated from a conversation in an interactive multi-user IM session, in accordance with some embodiments of the present invention;

FIG. 7 is an example in which a message posted to an interactive multi-user IM session is converted to an email and/or in which a non-registered user becomes a registered user, in accordance with some embodiments of the present invention; and

FIG. 8 is an example of clustering of conversation blocks of a multi-user instant messaging session into clusters for generating an email(s) for the clusters for sending to non-registered users, in accordance with some embodiments of the present invention.

### DETAILED DESCRIPTION

The present invention, in some embodiments thereof, relates to managing of messages and, more specifically, but not exclusively, to management of instant messages and emails exchanged between users.

As used herein, the term instant messaging (IM), such as IM session, is not necessarily limited to IM standards, formats, and/or technology, but is meant to encompass other messaging technologies that allow for real-time, synchronized, multi-user participation. IM allows multiple users to simultaneously post to a common platform which may be read by all other users, and where each user participating in the IM session is able to read all messages posted by the other users on the common platform.

As used herein, the term email is not necessarily limited to email standards, formats, and/or technology, but is meant to encompass other messaging technologies which are asynchronous, which are not designed for real time, and where one user at a time is able to send a message to other users by replying to a preceding email. Email relates to standalone messages which are forwarded to the recipients, where each recipient gets a copy of the email and can reply to one or more of the other recipients.

An aspect of some embodiments of the present invention relates to systems, methods, computing devices, and/or code instructions (stored on a data storage device and executable by one or more processors) for managing exchanges of messages between users using IM and email, by dynamically converting messages between IM and email to enable users using different messaging platforms to seamlessly communicate with each other, optionally within a single conversation. The messages may be part of a conversation between the users, which may include multiple topics. Users may require registration (i.e., referred to as registered users) in order to participate in a multi-user IM session. Users do not require registration (i.e. referred to as non-registered users) in order to participate in an email session. Registered users may communicate with other registered users via the multi-user IM session, and may communicate with non-registered users via email. Non-registered users may communicate with registered users via email, and with other non-registered users via email. Non-registered users are unable to access the multi-user IM session. Scalable storage solutions, for example, distributed databases and/or object storage systems, allow for efficient handling of large and dynamic datasets, ensuring data integrity and accessibility. Advanced clustering techniques, for example, semantic analysis and/or hybrid supervised-unsupervised methods, and group messages into contextually relevant categories. These techniques may be used to help ensure that conversations are logically organized, enhancing user accessibility and interaction.

An aspect of some embodiments of the present invention relates to systems, methods, computing devices, and/or code instructions (stored on a data storage device and executable by one or more processors) for enabling message transmission between registered user registered for posting on a multi-user instant messaging session and to non-registered users via email. Traditionally, messages exchanged via an IM session and emails are two distinct types of messages which are exchanged using distinct platforms which do not communicate with each other. One or more features of the process may be implemented by a processor(s) of a server, optionally an IM server that manages the IM session. The processor of the server executes a code for receiving a message posted to an interactive multi-user IM session by a registered user. The message posted to the IM session is destined for one or more recipients. A check of whether the respective recipient is a registered or non-registered is performed for each respective recipient. In response to the respective recipient being non-registered, the processor converts the message to an email. The email is sent to an email address of each respective non-registered recipient of the message. The system described herein may be designed to handle large-scale implementations, accommodating simultaneous users while maintaining low latency and/or high reliability.

Optionally, a reply email is sent by a first non-registered recipient that was sent the email (converted from the message posted to the IM session). The reply email is sent to an email account of the first registered user (which posted the message on the IM session from which the email to the first non-registered user was generated). The reply email may be deleted from the email account of the first registered user.

An aspect of some embodiments of the present invention relates to systems, methods, computing devices, and/or code instructions (stored on a data storage device and executable by one or more processors) for enabling message transmission between registered user registered posting on a multi-user instant messaging (IM) session and to non-registered users via email based on clustering of conversation blocks into clusters. One or more features of the process may be implemented by a processor(s) of a server, optionally an IM server that manages the IM session. The processor of the server executes a code for accessing a conversation between registered users interacting in an interactive multi-user IM session. The conversation may include postings of different messages by different registered users. The conversation covers different categories, for example, different topics of conversation, different aspects of a certain topic, and/or different messages posted by different registered users. The conversation is segmented into multiple segmented conversation blocks, for example, individually posted messages, a continuous portion of text of a single posted message, a set of sequentially posted messages, and the like. Each conversation block is analyzed using machine learning (ML) models, which dynamically group them into clusters based on semantic relationships and contextual relevance. ML techniques, for example, Transformer architectures and/or hybrid supervised-unsupervised processes, may be employed to categorize the blocks into topic-specific clusters, ensuring logical grouping even for non-sequential postings. Potential advantages of this clustering include facilitating precise categorization, simplifying information retrieval, and/or enhancing the organization of multi-topic conversations, for providing a scalable communication solution. A respective email corresponding to a respective cluster is generated by aggregating the segmented conversation blocks of the respective cluster. The generated email represents content of a specific category corresponding to the topic of the cluster. Multiple emails may be generated, where each email is generated for a different cluster. For example, where the conversation includes postings by users discussing three topics in a non-sequential order (e.g., a good travel destination, a recommended restaurant in the local city, and severe weather in another part of the country), three emails may be generated, for the three topics of discussion. One or more of the emails are sent to at least one non-registered user excluded from the interactive multi-user IM session. This enables the non-registered user to indirectly interact with the registered user participating in the IM session, without requiring becoming a registered user.

At least one implementation of the systems, methods, computing devices, and/or code described herein addresses the technical problem of managing messages exchanges between users using a combination of email and IM. Email and IM operate differently, and are not compatible using standard approaches. IM provides real-time synchronized exchanges of messages between users. A conversation occurring between two or more users via an interactive multi-user IM session involves users posting IM messages to each other and reading posted replies. IM conversations may include multiple short messages, which may cover different topics, not necessarily sequentially. In contrast, email provides non-synchronized exchange of messages between users, which may be slow or performed in real-time. A conversation occurring between two more users via email involves a user sending an email to one or more other users, and recipients replying to the sent email via a reply email. Emails are generally longer than IM messages partially due to their structured format, which typically includes headers, subject and signatures, and commonly cover a single topic. IM and email exchanges occur via different user interface and/or different messaging platforms, and therefore are disconnected from one another. A user selects to either communicate with one or more other users by either sending an IM message, or sending an email. At least one implementation of the systems, methods, computing devices, and/or code described herein improve the technology of digital message management. At least one implementation of the systems, methods, computing devices, and/or code described herein improve over standard approaches in which IM messages and email are distinct from one another, and are exchanged using different user interfaces and/or different platforms that are disconnected from each other. The user interface may feature adaptive layouts that adjust to various screen sizes, real-time notifications and/or multilingual support designed to enhance user engagement and/or productivity on a global scale. Adaptive user interfaces may be designed to intelligently synchronize layouts and/or data streams across a wide range of devices, including mobile, desktop, and augmented reality (AR) platforms. The interfaces may leverage real-time updates, multilingual support, and/or dynamic rendering to cater to diverse user preferences and/or accessibility needs. Integrating text, audio, and/or visual inputs within a unified platform, the system may be designed to deliver a multimodal communication experience. This adaptability may be designed to help ensure consistent usability and/or productivity across global teams operating in various environments and/or device ecosystems.

At least one implementation of the systems, methods, computing devices, and/or code described herein provide a solution for the aforementioned practical problem, and/or improve the aforementioned technology, and/or improve upon the aforementioned standard approaches, and/or provides a practical application of, seamlessly integrating email and IM messages between different users, enabling users to participate in a conversation with either email, IM, or both. Registered users may communicate with other registered users via the multi-user IM session, and may communicate with non-registered users via email, where the registered and non-registered user may participate in a single common conversation. Non-registered users are unable to directly access the multi-user IM session, but may participate in the single common conversation between the registered users occurring in the multi-user IM session, by sending an email.

At least one embodiment described herein relates to dynamic message conversion, advanced clustering processes, and/or real-time synchronization techniques to unify asynchronous and real-time communication systems. At least one embodiment is designed to help ensure seamless interaction between users on disparate platforms, enabling consistent and/or efficient exchanges.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Additionally, all communication data may be protected using end-to-end encryption and/or anonymization techniques, for ensuring user privacy and/or compliance with global data protection standards.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

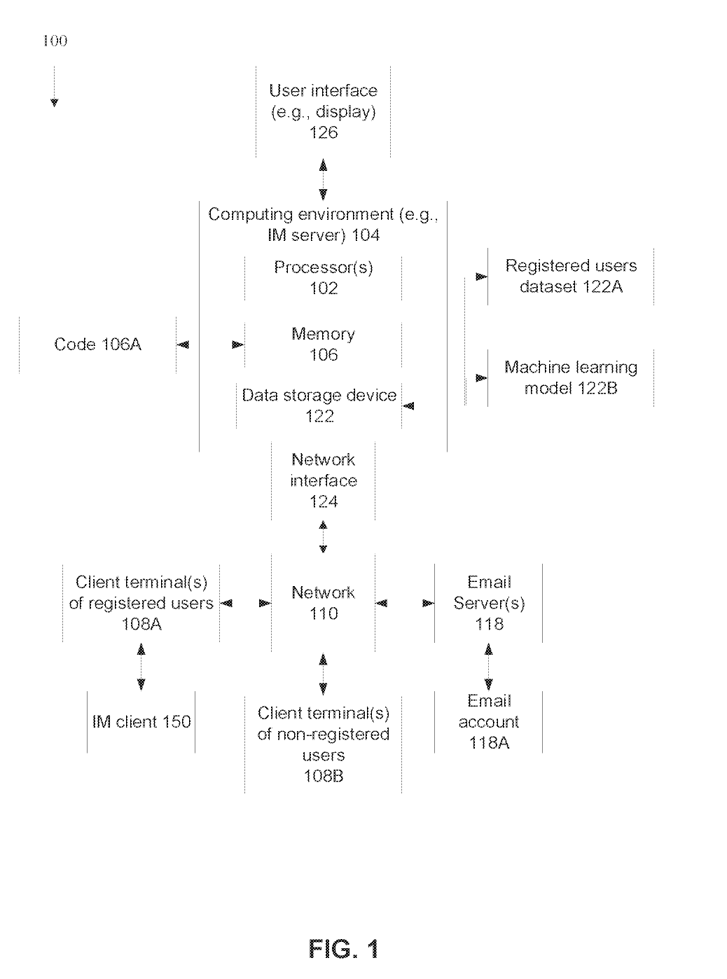

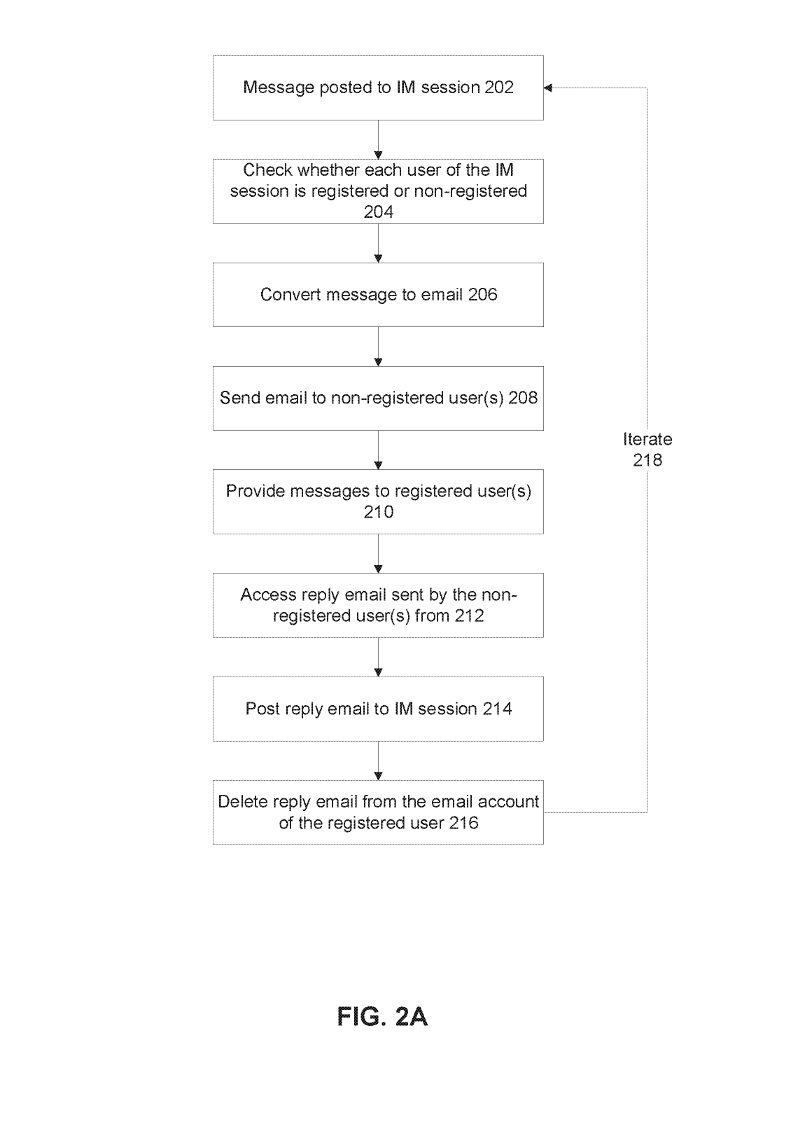

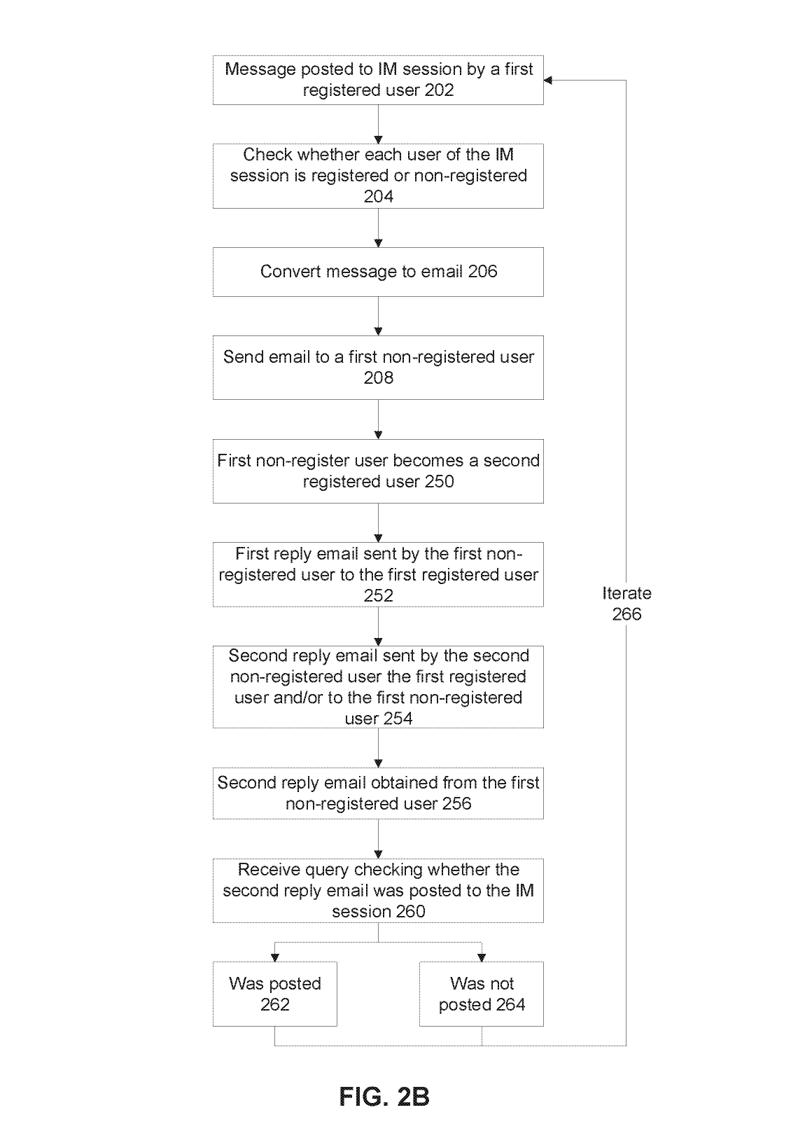

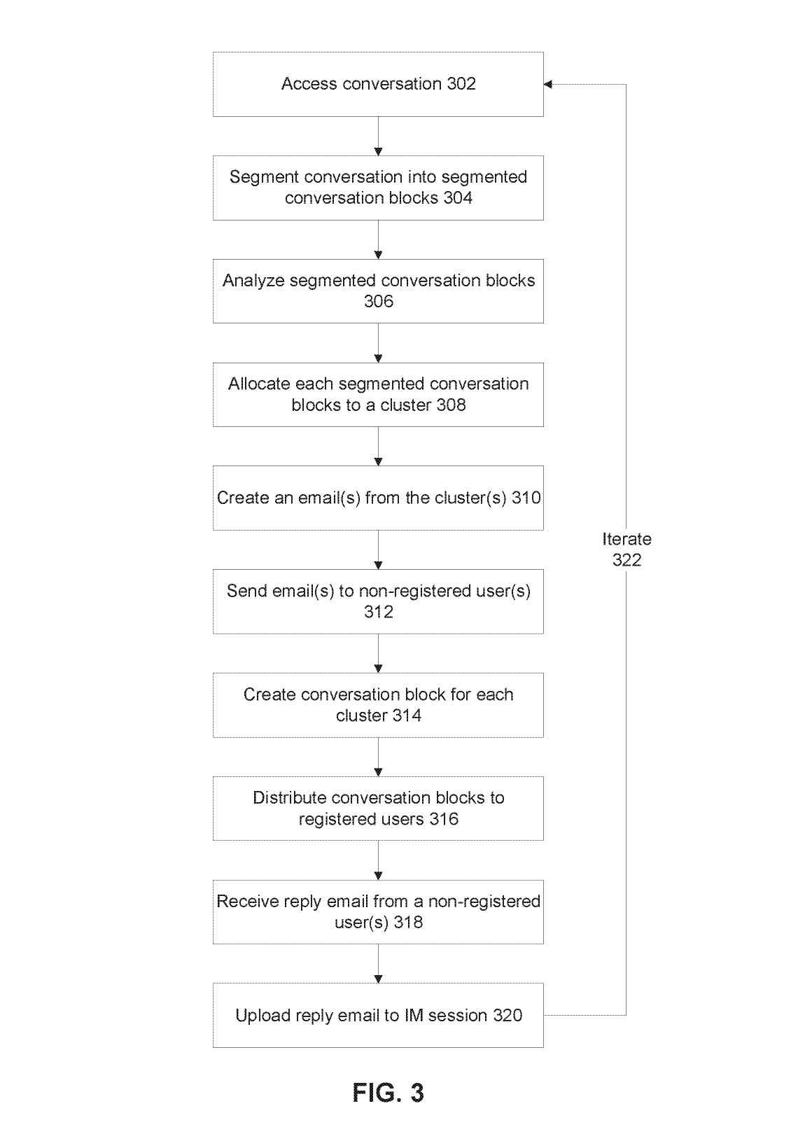

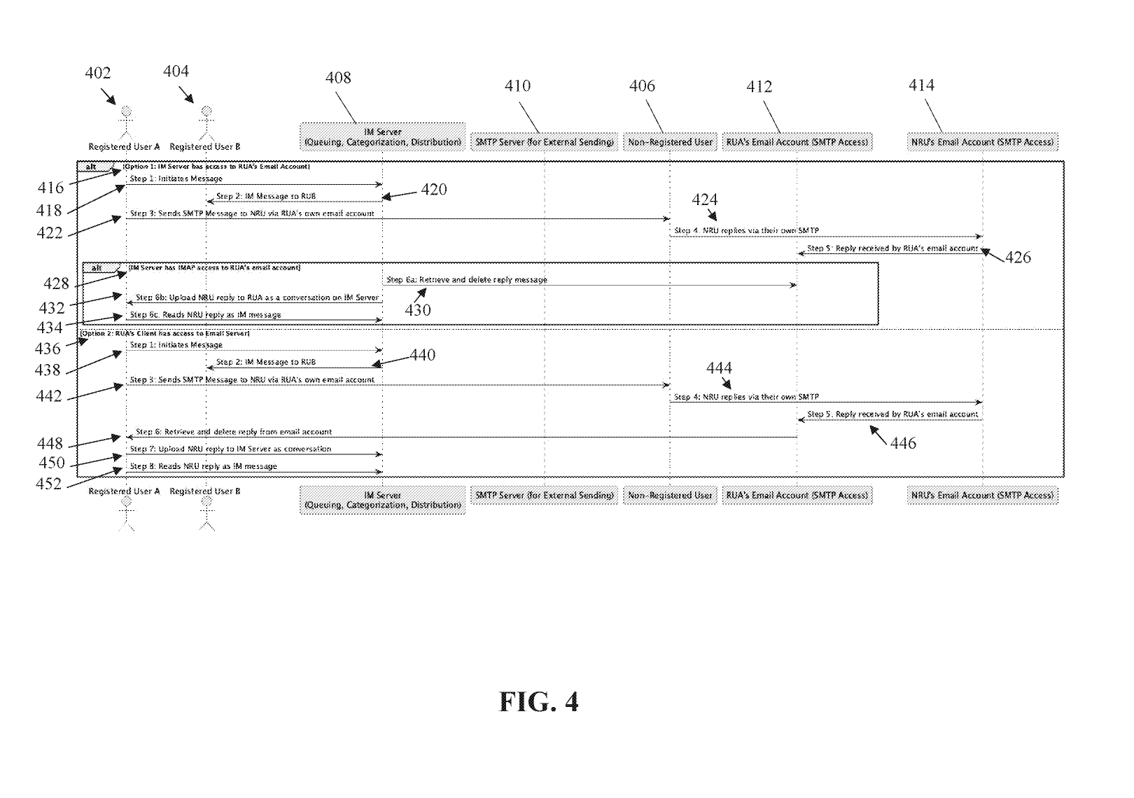

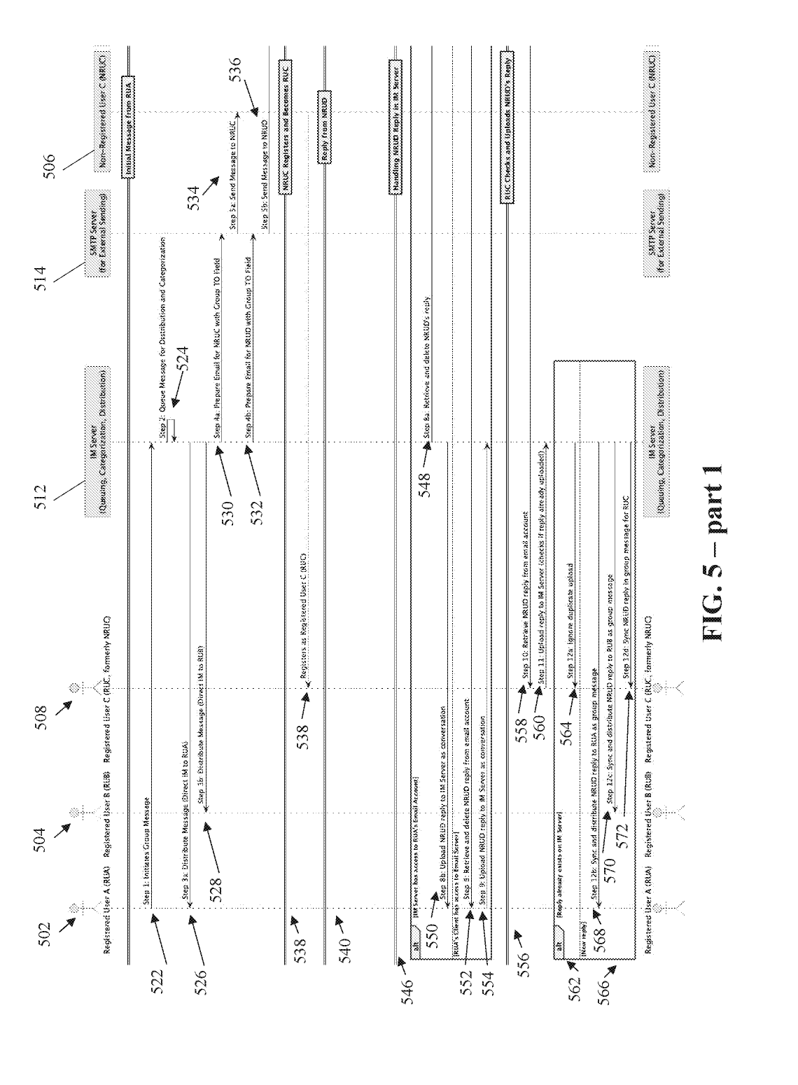

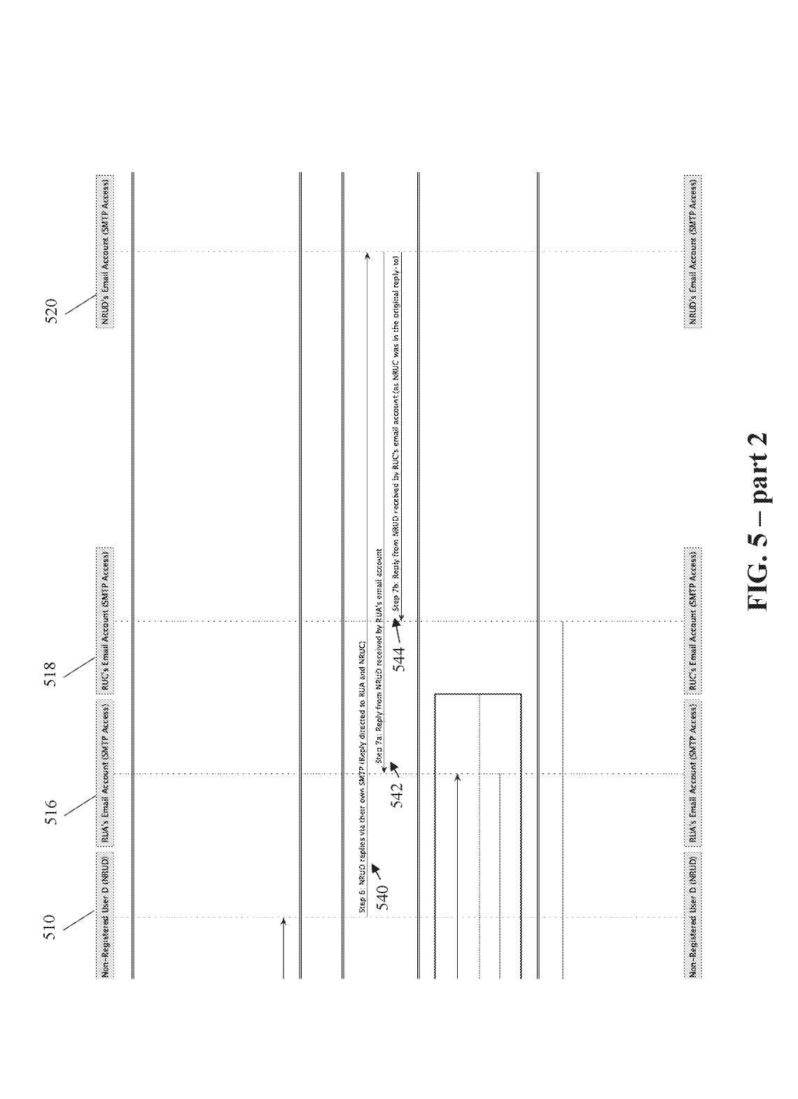

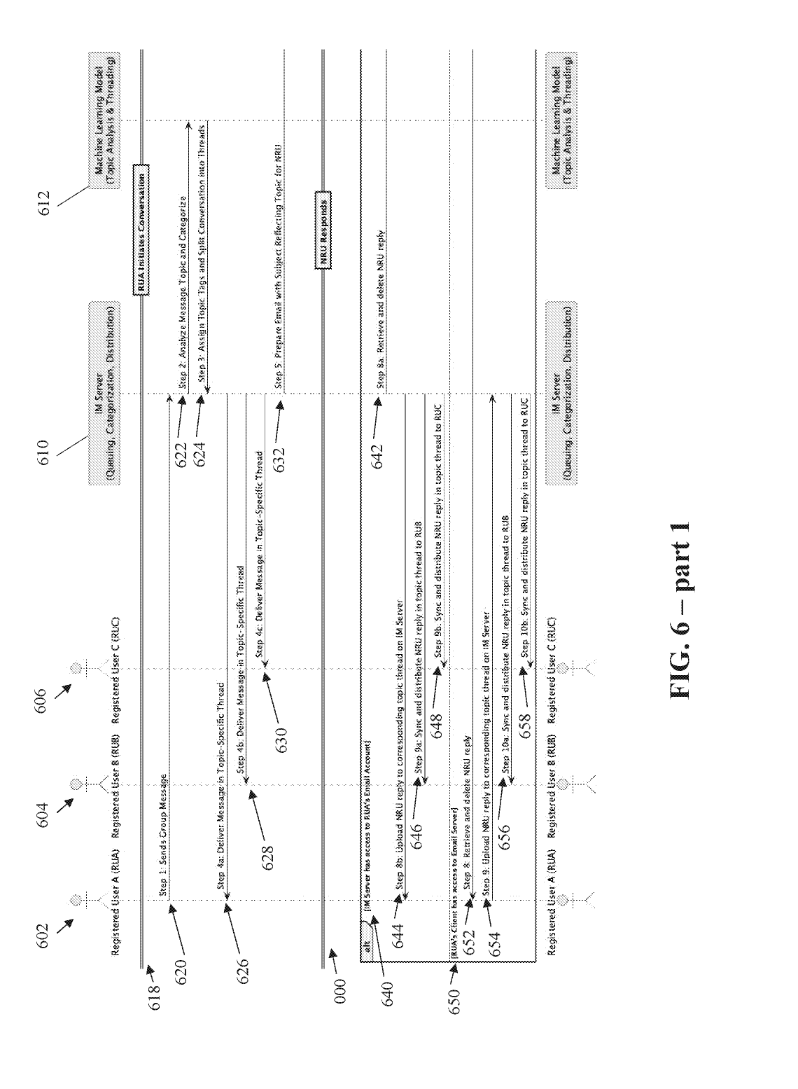

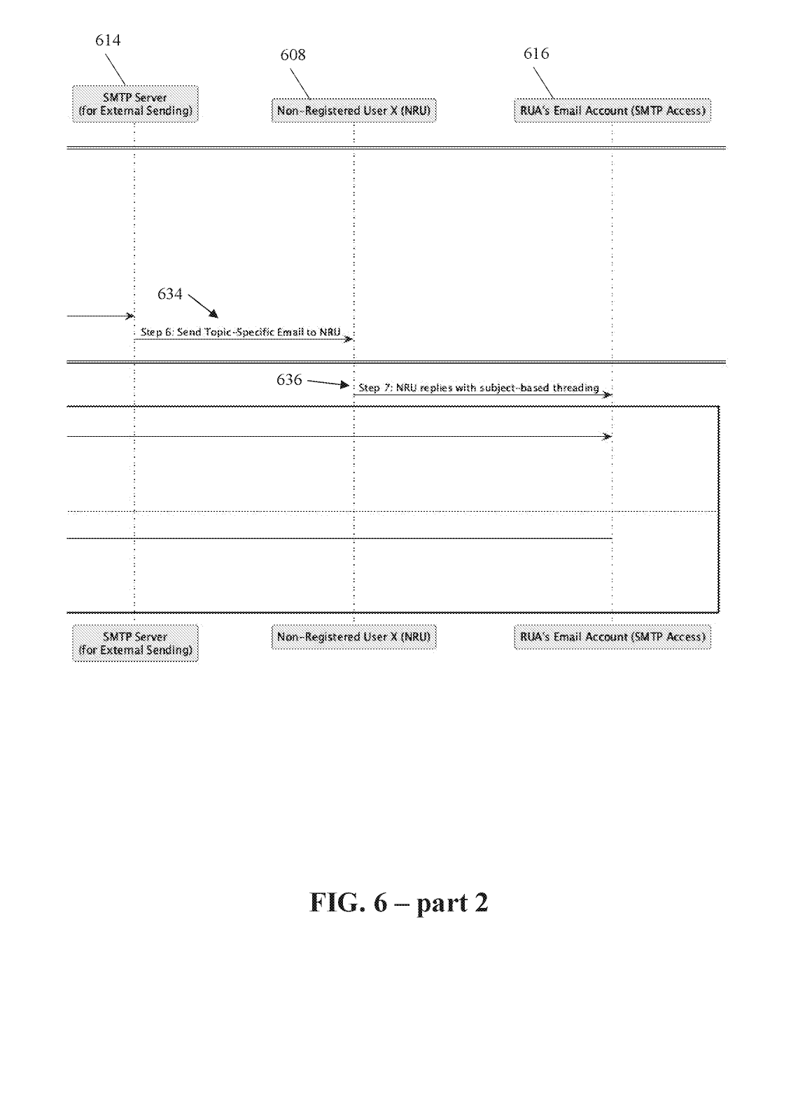

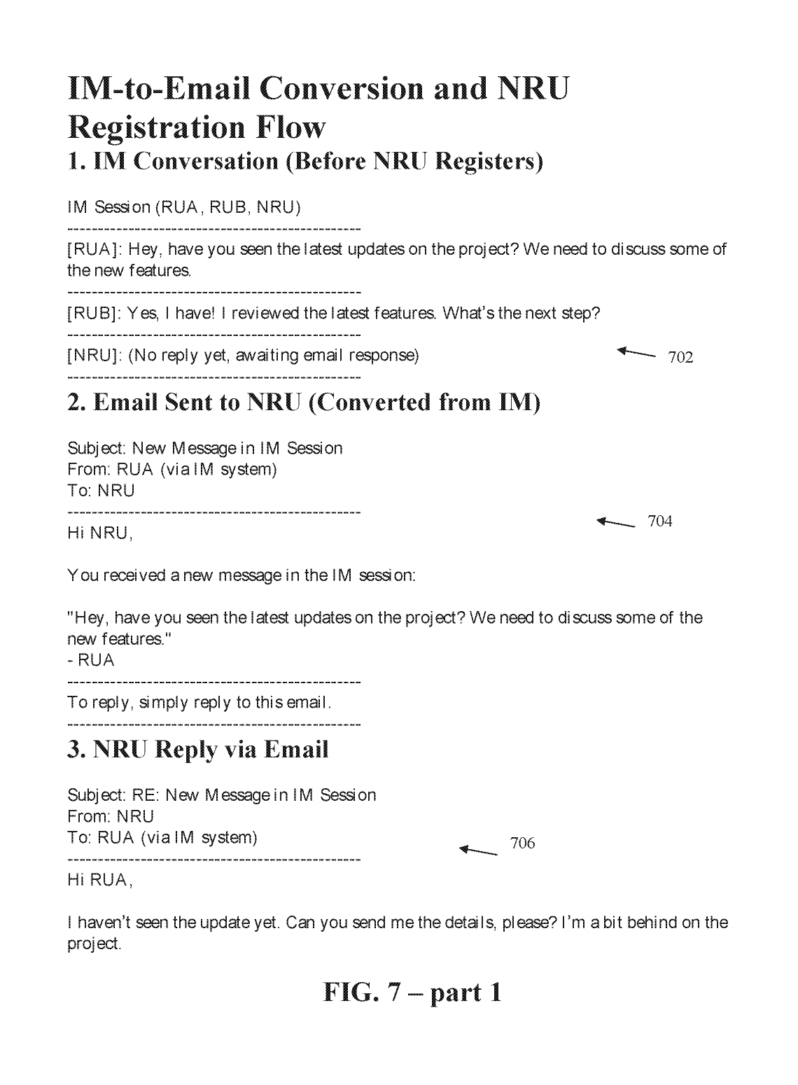

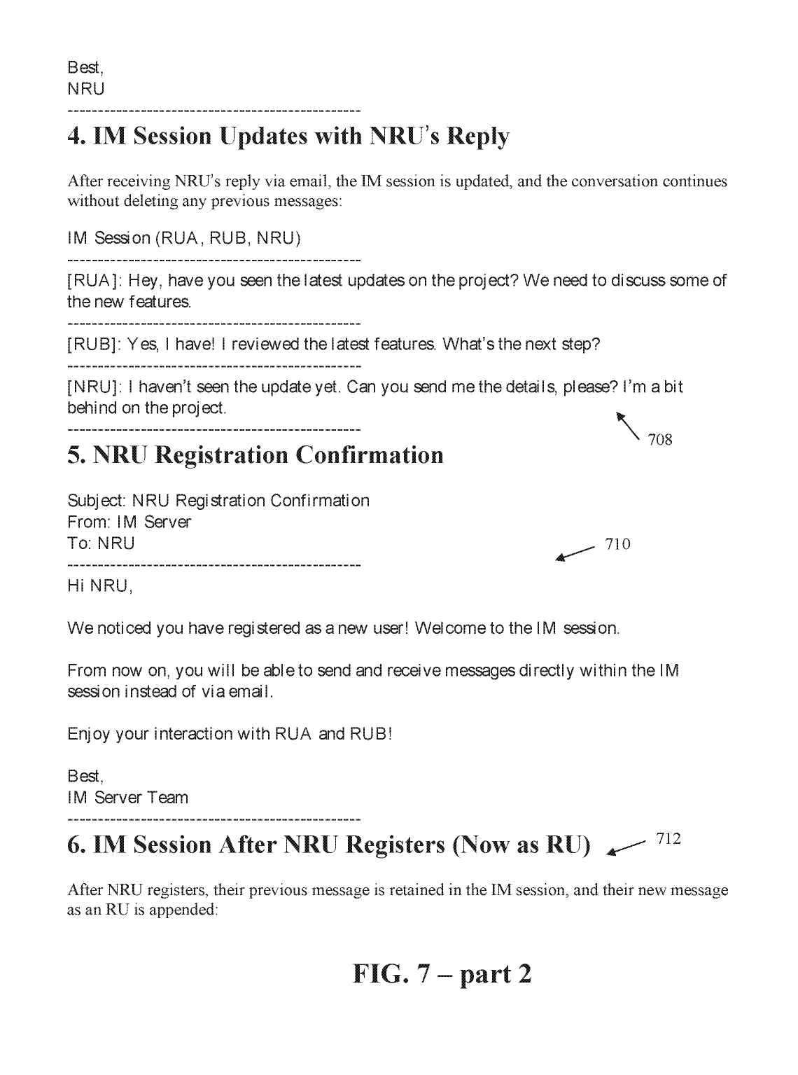

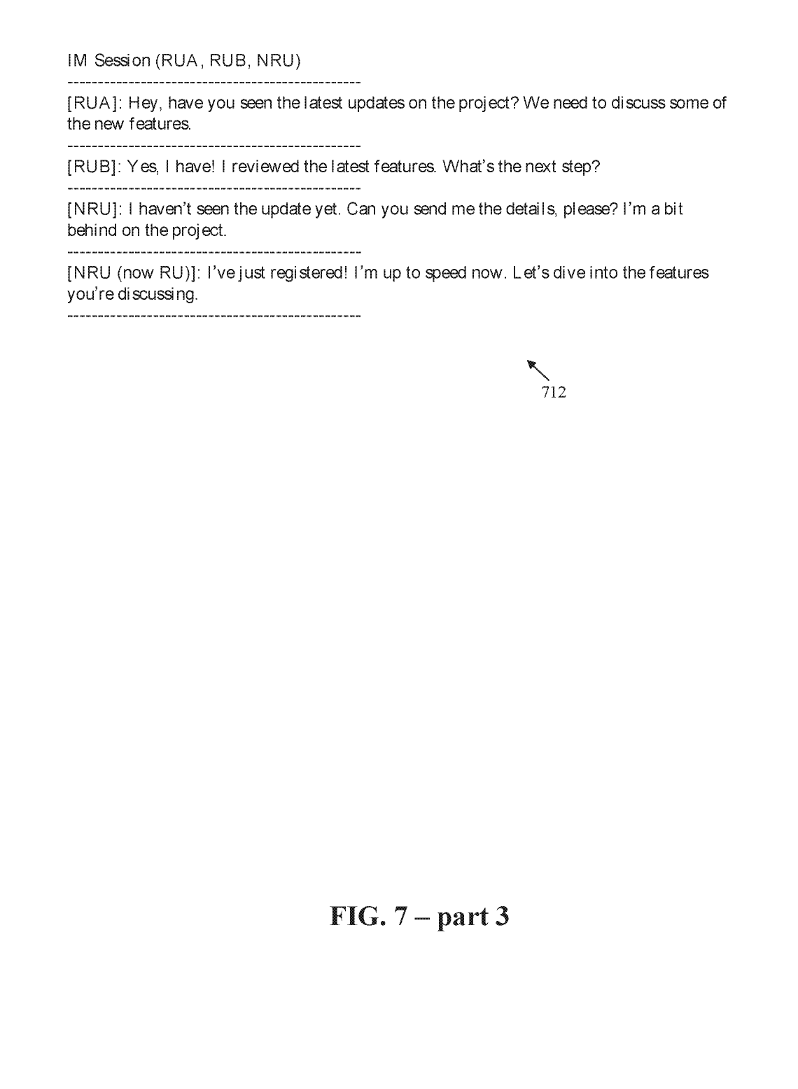

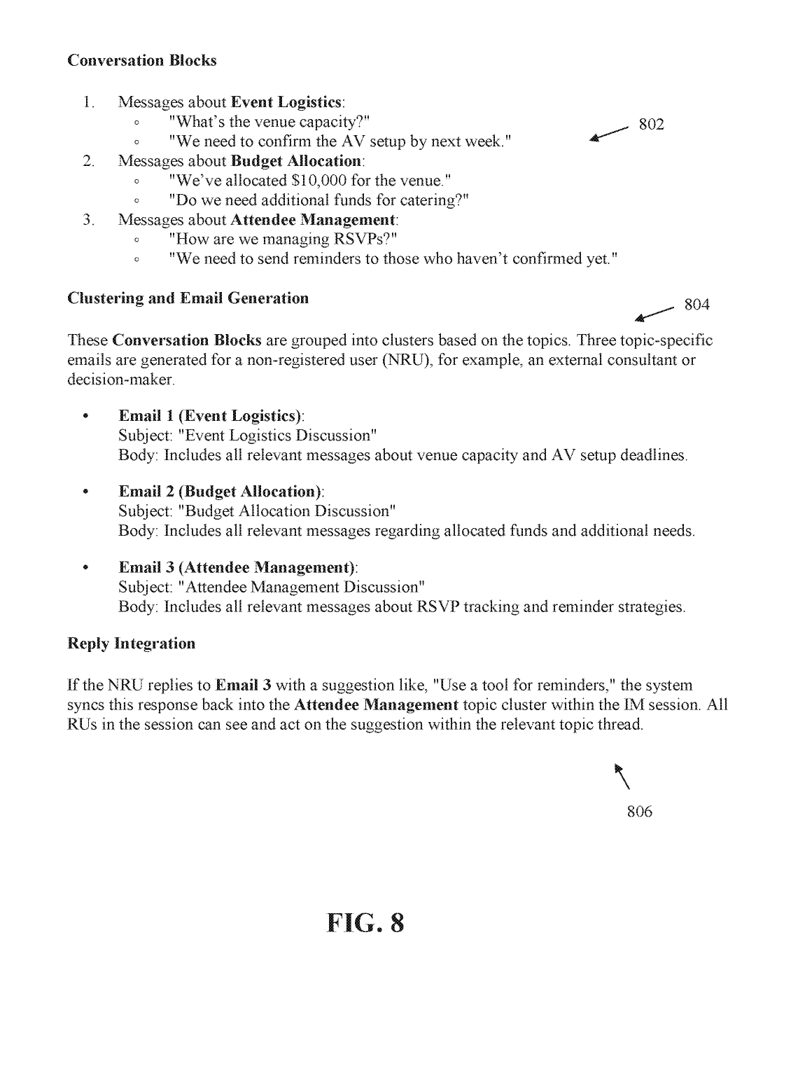

Reference is now made to FIG. 1, which is a block diagram of components of a system for managing a conversation between users exchanging IM and email messages, in accordance with some embodiments of the present invention. Reference is also made to FIG. 2A, which is a flowchart of a method of enabling message transmission between a registered user registered posting on a multi-user IM session and to non-registered users via email, in accordance with some embodiments of the present invention. Reference is also made to FIG. 2B, which is a flowchart of a method of enabling message transmission between a registered user registered and non-registered users where a non-registered user becomes a registered user, in accordance with some embodiments of the present invention. Reference is also made to FIG. 3, which is a flowchart of a method for enabling message transmission between registered users registered posting on a multi-user instant messaging (IM) session and non-registered users via email based on clustering of conversation blocks into clusters, in accordance with some embodiments of the present invention. Reference is also made to FIG. 4, which is a sequence diagram for enabling a conversation between registered and non-registered users via IM and email, in accordance with some embodiments of the present invention. Reference is also made to FIG. 5, which is a sequence diagram for enabling a conversation between via IM and email where a NRU becomes a RU, in accordance with some embodiments of the present invention. Reference is also made to FIG. 6, which is a sequence diagram for creating emails and/or threads based on clusters generated from a conversation in an interactive multi-user IM session, in accordance with some embodiments of the present invention. Reference is also made to FIG. 7, which is an example in which a message posted to an interactive multi-user IM session is converted to an email and/or in which a non-registered user becomes a registered user, in accordance with some embodiments of the present invention. Reference is also made to FIG. 8, which is an example of clustering of conversation blocks of a multi-user instant messaging session into clusters for generating an email(s) for the clusters for sending to non-registered users, in accordance with some embodiments of the present invention.

Referring now back to FIG. 1, components of system 100 may implement the acts of the method described with reference to FIGS. 2A-B, and 4-8, by processor(s) 102 of a computing device 104 executing code instructions stored in a memory 106 (also referred to as a program store).

Components of system 100 are for managing a conversation between client terminals of registered users 108A and client terminals of non-registered users 108B. Client terminals of registered users 108A access computing environment 104, which may be implemented as an IM server, for posting and viewing IM messages. Client terminals of registered users 108A may locally run an IM client 150 which communicates with computing device 104 (e.g., IM server), such as for synchronizing IM messages. Clients of non-registered users 108B may communicate with an email server(s) 118 for accessing email messages in corresponding email accounts 118A.

Computing environment 104 and/or email server(s) 118 may be implemented as, for example one or more and/or combination of: a group of connected devices, a network server, a web server, a virtual server, a computing cloud, and the like. These environments may leverage cloud computing infrastructure, for enabling scalable, fault-tolerant, and/or real-time message synchronization between registered and non-registered users. Cloud-based distributed systems may be leveraged to help ensure high availability, rapid scaling, and/or fault-tolerant operation for real-time communication.

Client terminals of registered users 108A and/or of non-registered users 108B may be implemented as, for example, a virtual machine, a desktop computer, a thin client, a network node, and/or a mobile device (e.g., a Smartphone, a Tablet computer, a laptop computer, a wearable computer, glasses computer, and a watch computer). Modern implementations may also include voice-activated devices, augmented reality interfaces, and/or wearable technology to broaden accessibility and user engagement.

Computing device 104 executing stored code instructions 106A, may be implemented as one or more servers (e.g., network server, web server, a computing cloud, and a virtual server) that provides centralized services for IM and/or other features of one or more methods described herein, such as for converting between IM and email messages, dividing an IM conversation into clusters of topic related messages, and the like. Services may be provided, for example, to one or more client terminals of registered users 108A and/or one or more client terminals of non-registered users 108B over network 110. Computing device 104 may communicate with email server(s) 118, for example, when providing an email generated from IM messages. Services may be provided to client terminals 108A and/or B and/or server(s) 118, for example, as software as a service (SaaS), a software interface (e.g., application programming interface (API), software development kit (SDK)), IM client 150 for local download to the client terminal(s) 108A-B, an add-on to a web browser running on client terminal(s) 108, and/or providing functions using a remote access session to the client terminals 108, such as through IM client 150 and/or a web browser executed by client terminal 108 accessing a web sited hosted by computing device 104.

Processor(s) 102 of computing device 104 may be hardware processors, which may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 stores code 106A that implements one or more features and/or acts of the method of the IM server described with reference to FIGS. 2A-B, and 4-8 when executed by hardware processor(s) 102.

Computing device 104 may include a data storage device 122 for storing data, such as one or more code based processes and/or data repositories described herein, for example, a registered users dataset 122A set to store indication of which users are registered for participating in IM sessions, machine learning model 122B that clusters messages in an IM session into clusters such as per-topic, as described herein. Data storage device 114 may be implemented as, for example, a memory, a local hard-drive, virtual storage, a removable storage unit, an optical disk, a storage device, and/or as a remote server and/or computing cloud (e.g., accessed using a network connection). Feedback loops may continuously improve the ML models by analyzing evolving interaction patterns and/or dynamically updating based on real-time user data.

Network 110 may be implemented as, for example, the internet, a local area network, a virtual network, a wireless network, a cellular network, and/or combinations of the aforementioned.

Computing device 104 may include a network interface 124 for connecting to network 110, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 and/or client terminal(s) 108A-B include and/or are in communication with one or more physical user interfaces 126 that include a mechanism for a user to enter data (e.g., enter an IM message and/or email) and/or view data (e.g., view IM messages and/or emails from other users), within a GUI. Exemplary user interfaces 126 include, for example, one or more of, a touchscreen, a display, gesture activation devices, a keyboard, a mouse, and voice activated software using speakers and microphone. The user interface may synchronize layouts and/or data streams seamlessly across devices, for example, mobile, desktop, and/or augmented reality (AR) platforms, for helping to ensure accessibility and/or consistency. The user interface may integrate real-time notifications, adaptive layouts, and/or multi-language support to enhance the user experience across diverse platforms.

Referring now back to FIG. 2A, the flowchart of the method of enabling message transmission between a registered user registered posting on a multi-user IM session and to non-registered users via email, in presented. One or more features of the method may be performed by a server, optionally an IM server, and/or by other computing devices.

At 202, a message is posted to an interactive multi-user IM session by a registered user. The message is posted for access by multiple users participating in the IM session, which includes registered users and/or non-registered users. The users participating in the IM session may be referred to herein as recipients, i.e., which receive the posted message, either directly within the IM session for registered users, or indirectly via an email message for unregistered users. The system may dynamically format content for compatibility across IM and/or email platforms, for preserving message integrity while adapting to platform-specific constraints, for example, text length and/or attachment size.

The different registered users may each post their own messages to the IM session. The postings to the IM session by the different registered users are presented on client terminals of each of the different registered users. The IM session may be dynamically synchronized between the client terminals of the different registered users, such that each registered user is able to see postings by all other registered users in real time, and/or each registered user may post to the IM session for viewing by all other registered users in real time.

At least one embodiment enables the non-registered users to participate in the conversation with the registered users, without transforming the non-registered users to registered users, and/or without requiring granting the non-registered users permission to directly join the IM session.

At 204, a check is performed to determine whether each respective user (i.e., recipient) participating in the IM session is a registered user or a non-registered user. For example, by looking up each respective user (i.e., recipient) in a dataset indicating whether the respective recipient is registered or non-registered.

The registered users are registered for interacting with the multi-user IM session. Each registered user is registered for posting (i.e., sending) messages to the multi-user IM session, and for reading messages posted to the multi-user IM session by other registered users. Interfaces presenting the multi-user IM session on each client terminal used by multiple registered user may be synchronized in real-time, such that all registered users see the same set of messages posted to the multi-user IM session in real-time.

Non-registered users are excluded from the interactive multi-user IM session, such that the non-registered users cannot directly post messages to the IM session and cannot directly view the messages posted to the IM session. The non-registered users may indirectly participate in the multi-user IM session, without being granted permission to directly post to the IM session and/or to read messages posted to the IM session. The non-registered users may participate in the conversation with the registered users of the IM session via sending and receiving email messages, which are converted to/from messages posted/for posting on the multi-user IM session, according to at least one embodiment described herein.

At 206, the message posted to the interactive multi-user IM session is converted to an email message. Artificial intelligence models may analyze the context and/or tone of the original message which may ensure that the email is appropriately formatted and/or maintains the conversation's intent.

The conversion may be done by extracting the content of the posted message, and inserting the extracted content into an email message. The content may include, for example, text, attachments, images, animations, videos, links, documents, and the like.

The email is generated for sending to each non-registered user. The email addresses of the non-registered user(s) may be automatically inserted in the “to” field. The email address of the registered user that posted the message (which is converted into the current email) may be placed in a “reply-to” field. The email address of the other registered users participating in the IM (but which did not post the current message used to create the current email) may be placed in a “cc” field. The “subject” field of the email may be automatically filled, for example, by a generic title such as “IM session”, and/or by more specific content such as a topic of conversation of the IM session. Contextual cues and/or metadata may be appended to emails, which may ensure that conversation threads remain coherent across platforms.

At 208, the email is sent to the email address of each non-registered user. Each non-registered user is able to reply to the registered user that posted the message that generated the email, by generating a reply email.

At 210, other registered users participating in the interactive multi-user IM session are able to view the message posted to the IM session.

Optionally, the message is sent to each respective client terminal of each of the registered users participating in the IM session, for posting to the interactive multi-user IM session. The IM sessions may be synchronized across the client terminals of the registered users, such that each respective display of each respective client terminal of each registered user presents the same set of posted messages in real time.

Alternatively, the message is posted to the IM session hosted by a server, which may be simultaneously accessed by multiple client terminals of the registered users. The central hosted IM sessions provides synchronization of the messages posted to the IM session across the displays of the client terminals of the registered users. Real-time synchronization integrates IM and email platforms, which may ensure seamless and/or dynamic updates across devices and/or user interfaces for a unified communication experience. Multi-thread synchronization may ensure consistency and/or coherence across parallel conversations, which may enhance the overall user experience during simultaneous discussions.

At 212, a reply email sent by the non-registered user (which received the email) may be accessed from an email account of the registered user which posted the message (that generated the email). The system described herein may incorporate reply tracking, which may ensure that responses are aligned with the appropriate conversation thread within the IM session.

When the non-registered user sends the reply email in response to the automatically generated and sent email which includes the contents of the message posted by the registered user, the reply email may include the email address of the registered user as a destination. Reply emails may be seamlessly threaded into corresponding IM conversations, for maintaining context and ensuring chronological integrity.

At 214, the reply email is posted to the interactive multi-user IM session.

The reply email may be posted by extracting the content of the posted message, inserting the extracted content into an IM message, and posting the IM message to the IM session. The content may include, for example, text, attachments, images, animations, videos, links, documents, and the like. The IM message generated from the email may be posted under the credentials of the non-registered user, which may indicate to the other users that the posting user is non-registered.

The reply email may be accessed from the email account of the registered user and/or the accessed reply email may be posted to the IM session, for example, by a processor of a server such as the IM server, and/or by client code running on the client terminal used by the registered user, and the like. The reply email may be directly accessed from the email account, and/or the reply email may be obtained by instructing an email server to provide the email from the email account.

In the case of multiple registered users participating in the interactive multi-user IM session, the reply email posted as an IM message to the IM session is presented on a display of a client terminal of each one of the registered users. The reply email posted to the IM session may be synchronized across the client terminals of the registered users, for enabling real-time viewing and/or response.

The reply email may be posted to the interactive multi-user IM session (as an IM message) as a continuation to a conversation between multiple users, including the registered user that posted the message (to which the reply email is generated in response to), the non-registered user that generated the reply email, and optionally other registered and/or non-registered users.

At 216, the reply email may be deleted from the email account of the registered user. The reply email may be deleted after the reply email is obtained from the email account. The reply email may be directly deleted from the email account of the registered user, and/or indirectly deleted by instructing the email server to delete the reply email. The reply email may be deleted, for example, by the processor(s) of the IM server, the client code running on the client terminal of the registered user that originated the messages, and/or other devices.

At 218, one or more features described with reference to 202-216 may be iterated. The iterations may be performed in real time, in response to messages being posted to the IM session by registered users, and/or in response to emails from non-registered users to be posted to the IM session. The emails from non-registered users may be in response to emails generated from messages posted to the IM session by registered users.

Referring now back to FIG. 2B, the flowchart of the method of 2B is based on the method of FIG. 2A for enabling message transmission between a registered user registered and non-registered users, with the added features for handling the case where a non-registered user becomes a registered user. One or more features of the method may be performed by a server, optionally an IM server, and/or by and/or by client code running on a device of a registered user participating in the interactive multi-user IM session, for example, as described herein.

202-206 are as described with reference to FIG. 2A.

At 208, the email is sent to an email account of the first non-registered user.

Optionally, the email is further send to an email account of a second non-registered user.

At 250, the first non-registered user registers to become a second registered user, which enables the second registered user (previously the first non-registered user) to participate in the interactive multi-user IM session.

The change in state of the first non-registered user to becoming (e.g. by registering) the second registered user may occur after the email is sent to the email address of the first non-registered user and/or send to the email address of the second non-registered user. The change in state may occur prior to a response email being sent.

At 252, a first reply email may be sent by the first non-registered user to the first registered user as a response to the email.

The first reply email may be obtained from the email account of the first registered user, for example, as described with reference to 212-216 of FIG. 2A. An updated interactive multi-user IM session including the first reply email posted as an IM message may be presented on a display of a client terminal of the second registered user participating in the interactive multi-user IM session. Due to the change in state, the second registered user is now able to directly view the reply email which they sent while in the previous state as the first non-registered user, as an IM message posted to the IM session.

At 254, a second reply email may be sent by the second non-registered user to an email account of the first registered user and/or to the email account of the first non-registered user.

At 256, the second reply email may be obtained from the email account of the first non-registered user that converted to become the second registered user. The email may be obtained by code running on a client terminal of the second registered user (which was previously the first non-registered user) and/or by the IM sever.

At 260, a query may be received from the client terminal of the second registered user checking whether the second reply email has been posted to the interactive multi-user IM session

At 262, in response to an indication that the second email reply has not been posted to the interactive multi-user IM session, the second reply email may be obtained and posted to the interactive multi-user IM session. The second reply email may be obtained from the client terminal of the second registered user.

An updated interactive multi-user IM session including the second reply email posted as an IM message may be presented on a display of a client terminal of the second registered user participating in the interactive multi-user IM session. Due to the change in state, the second registered user is now able to directly view the second reply email as an IM message posted to the IM session. The second reply email which was sent from the second non-registered user while the second registered user was in the previous state as the first non-registered user.

Alternatively, at 264, in response to an indication that the second reply email has been posted to the interactive multi-user IM session, the second reply email from the client terminal of the second registered user may be ignored.

The second reply email previously posted to the IM session may have been obtained from the email account of the first registered user, since the second email was sent to both the first registered user and to the first non-registered user. When the second reply email has been already uploaded from the email account of the first registered user, there is no need to upload it from the email account of the first non-registered user (current the second registered user), since the emails are duplicates of the same second reply email sent by the second non-registered user.

At 266, one or more features described with reference to 202-264 may be iterated. The iterations may be performed in real time, in response to messages being posted to the IM session by registered users, and/or in response to emails from non-registered users to be posted to the IM session. The emails from non-registered users may be in response to emails generated from messages posted to the IM session by registered users.

Referring now back to FIG. 3, a method for enabling message transmission between registered users registered posting on a multi-user instant messaging (IM) session and non-registered users via email based on clustering of conversation blocks into clusters, is presented. One or more features of the method may be performed by a server, optionally an IM server, and/or by client code running on a device of a registered user participating in the interactive multi-user IM session, for example, as described herein. This method may utilize (e.g., state-of-the-art) clustering processes to organize conversation blocks by topic, which may streamline information flow between IM and email systems. Machine learning models may dynamically adapt to conversational context, which may ensure seamless integration and/or categorization. Additionally, before sending an email to a non-registered user (NRU), the system described herein may analyze the content of the message to determine its urgency. For example, if the sender's message includes phrases like 'checking' or 'give me a second,' the system may delay sending the email and wait for additional context or messages from the sender to provide a more complete and coherent email.

At 302, a conversation between registered users interacting in an interactive multi-user IM session is accessed. The different registered users may each post their own messages to the IM session. The postings to the IM session by the different registered users are presented on client terminals of each of the different registered users. The IM session may be dynamically synchronized across client terminals of the different registered users, such that each registered user is able to see postings by all other registered users in real time, and/or each registered user may post to the IM session for viewing by all other registered users in real time.

The conversation covers different categories, for example, different topics of conversation, different aspects of a certain topic, and/or different messages posted by different registered users.

The conversation may include text and optionally other media elements, for example, images, symbols, emoticons, videos, animations, links, and the like.

At 304, the conversation may be segmented into multiple segmented conversation blocks.

Segmentation may be performed per posted message, sentence, and/or sequence of messages by a single user. The generated segmented conversation blocks represent coherent units of dialogue, such as individually posted messages, continuous portions of text from a single posted message, or a set of sequentially posted messages. Advanced semantic segmentation techniques leverage models like Sentence-BERT to analyze meaning and/or ensure that conversation blocks are both contextually coherent and logically structured, enhancing readability and thematic organization. The segmentation may be performed by segmentation code, for example, based on natural language processing (NLP), based on recognition of features of the conversation (e.g., looking for periods at the end of a sentence, looking for which user posted the message, and the like). Integration of natural language processing (NLP) techniques may allow for identifying sentence boundaries, user attributions, and/or topic changes, which may enhance segmentation accuracy and/or relevance. Advanced segmentation may be achieved, for example, using Transformer-based architectures such as BERT or GPT, which may enable semantic analysis and/or precise context extraction. Semantic segmentation leverages models like Sentence-BERT for finer-grained analysis based on meaning, which may ensure that conversation blocks are contextually coherent and/or logically structured. This may enhance readability and/or thematic organization while improving the segmentation process’s overall accuracy.

At 306, each of the segmented conversation blocks is analyzed. The analysis may be performed dynamically during the current conversation session, for example, in response to identification of a new segmentation, after a predefined amount of time has elapsed, after a predefined number of new messages have been posted, and the like. Alternatively or additionally, the analysis may be performed after the current conversation session.

Optionally, the analysis is performed by feeding each segmented conversation block into one or more machine learning models. The machine learning model(s) generates a classification category for each segmented conversation block. The classification category assigned to each segmented conversation block may be selected from multiple defined classification categories.

Optionally, the machine learning model(s) is trained using a supervised approach on a training dataset of records. A record may include a sample segmented conversation block and a corresponding ground truth label indicating the classification category. Federated learning models may enable decentralized training across user devices, which may enhance privacy and/or minimize centralized data dependencies.

Alternatively or additionally, the machine learning model(s) may be trained using a non-supervised approach on a training dataset of sample segmented conversation blocks. The machine learning model may cluster the sample segmented conversation blocks into multiple clusters, and assign a classification category to each cluster, for example, using NLP approach to identify a common theme/topic of the segmented conversation block in the cluster.

Alternatively or additionally, the segmented conversation blocks may be dynamically clustered into multiple clusters by a clustering machine learning model(s) using a non-supervised approach. Each dynamically generated cluster corresponds to a certain category. The category may be dynamically determined for each cluster, for example, using NLP approach to identify a common theme/topic of the segmented conversation block in the cluster.

Hybrid clustering methods integrate hierarchical techniques with density-based approaches, offering flexibility in managing complex and/or diverse conversation datasets. This combination may ensure that clustering is robust and/or adaptable, accommodating varying data distributions and use cases.

Incremental DBSCAN allows for real-time clustering of dynamic datasets, which may ensure message grouping adapts as new data is introduced during conversations. This approach may be particularly effective for continuously evolving conversations, maintaining accurate clustering without requiring complete dataset reprocessing.

Dynamic clustering may employ hybrid supervised and unsupervised techniques, integrating topic modeling and/or semantic similarity scoring for precise classification. Contextual embeddings such as RoBERTa and LASER may enhance multilingual and/or multi-domain clustering accuracy.

Clustering techniques for example K-Means for batch processing of large datasets, may enable efficient and/or scalable grouping of messages into distinct topics. This approach may ensure that even large-scale conversations are categorized effectively, reducing computational overhead while maintaining high accuracy.

Temporal clustering organizes messages based on chronological sequences, may enable effective analysis of time-sensitive conversations. This approach may ensure that discussions occurring within specific time windows are grouped together, allowing for better context preservation and streamlined retrieval of time-critical information.

Explainability techniques, such as SHAP (SHapley Additive exPlanations) and LIME (Local Interpretable Model-Agnostic Explanations), may be integrated into the system described herein, which may enhance transparency and/or user trust in the clustering process. These tools may provide actionable insights into the decisions made by clustering processes, illustrating how specific features, such as semantic similarity and/or contextual embeddings, influence the categorization of conversation blocks. By visualizing the factors contributing to each clustering decision, users may gain a deeper understanding of the system’s operations. This may foster confidence in automated processes while enabling users to make informed adjustments to the clustering parameters when needed, which may ensure the system remains reliable and/or adaptable to evolving requirements.

The architectures of the machine learning model(s) may be selected to enable handling structured and/or unstructured conversations, such as with adaptability.

Exemplary architectures of ML models described herein trained using a supervised approach and/or non-supervised approach include: for example, a statistical classifier and/or other statistical model, neural networks of various architectures (e.g., convolutional, fully connected, deep, encoder-decoder, recurrent, transformer, graph), support vector machines (SVM), logistic regression, k-nearest neighbor, decision trees, boosting, random forest, a regressor, and/or any other commercial or open source package allowing regression, classification, dimensional reduction, supervised, unsupervised, semi-supervised, and/or reinforcement learning. Neural-symbolic integration may combine the efficiency of neural networks with rule-based reasoning for superior contextual understanding and/or decision-making. Additional advancements may include graph neural networks for contextual relationships and/or reinforcement learning to refine clustering models over time.

At 308, each segmented conversation block is allocated to a cluster according to the analysis. Each cluster may represent, for example, a specific subject discussed in the conversation session.

Optionally, in the implementation of feeding segmented conversation blocks into the ML model, each segmented conversation blocks assigned a classification category by the ML model is allocated to the cluster corresponding to the classification category.

Alternatively, in the implementation in which the segmented clusters are clustered by the ML model, the segmented conversation blocks are dynamically allocated to the clusters during generation of the clusters.

At 310, one or more emails are created from the clusters, by aggregating segmented conversation blocks allocated to the clusters into one or more emails.

Optionally, each individual email corresponds to a single cluster. The email is generated by aggregating the segmented conversation blocks allocated to the cluster. For example, the single cluster is topic-specific. Alternatively, an individual email may be created for two or more clusters, which may be of similar topics. For example, for two clusters, one discussing vacation destinations, and another discussing restaurants, the email may be divided into two sections, or two paragraphs, each corresponding to a different cluster.

The email may be generated using different approaches. Optionally, the original text of the segmented conversation blocks allocated to the cluster is inserted according to the original order of the original conversation. Alternatively, the original text of the segmented conversation blocks allocated to the cluster are used as a basis for generation of the email, by amending the original text and/or order. For example, the original text of the segmented conversation blocks may be fed into a large language model (LLM) as part of a prompt instructing the LLM to generate an email as an aggregation of the segmented conversation blocks. The LLM may be instructed in the prompt as to the amount of modification to make to the original language and/or sequence.

At 312, the email(s) is sent to one or more non-registered users.

The non-registered users are excluded from the interactive multi-user IM session, such that the non-registered users cannot directly post messages to the IM session and cannot directly view the messages posted to the IM session.

The email address(es) of the non-registered user(s) may be automatically inserted into the “to” field of the email. The email addresses(es) of the non-registered user(s) whose messages were used to create the email may be automatically inserted into the “from” field of the email. The email address(es) of the other registered user(s) participating in the IM session (which may be viewing without posting) may be automatically inserted into the “reply-to” field. The category of the cluster used to generate the email, optionally the topic, may be automatically inserted into the “subject” field of the email.

The email(s) is not necessarily sent to the registered users participating in the IM session, since the registered users are able to directly participate in the IM session.

The non-registered users may be designated for participation in the conversation with the non-registered users of the IM session, for example, by being granted a defined permission.

The generation of the email(s) from the messages of the conversation posted to the IM session enables the non-registered users to participate in the conversation with the registered users, without transforming the non-registered users to registered users, and/or without requiring granting the non-registered users permission to directly join the IM session.

At 314, a conversation block may be created for each cluster. Multiple conversation blocks may be created corresponding to the multiple clusters.

The conversation blocks may be formatted and/or may generated to comply with the format and/or standard of messages for posting to the IM session.

The conversation block may be created by aggregating segmented conversation blocks allocated to the respective clusters.

Optionally, each individual conversation block corresponds to a single cluster. The conversation block is generated by aggregating the segmented conversation blocks allocated to the cluster. Alternatively, an individual conversation block may be created for two or more clusters, which may be of similar topics.

The conversation block may be generated using different approaches. Optionally, the original text of the segmented conversation blocks allocated to the cluster is inserted according to the original order of the original conversation. Alternatively, the original text of the segmented conversation blocks allocated to the cluster are used as a basis for generation of the conversation block, by amending the original text and/or order. For example, the original text of the segmented conversation blocks may be fed into a large language model (LLM) as part of a prompt instructing the LLM to generate a conversation block as an aggregation of the segmented conversation blocks. The LLM may be instructed in the prompt as to the amount of modification to make to the original language and/or sequence.

At 316, the conversation blocks are distributed to the registered users of the interactive multi-user IM session.

Each registered may receive the same set of conversation blocks. Each registered user may receive multiple conversation blocks, corresponding to the multiple clusters.

The conversation blocks may be distributed as cluster-specific threads, such as topic-specific threads.

At 318, a reply email may be received from the non-registered user(s) to which the generated email was sent.

The reply email may be sent in response to a certain email generated from a certain cluster. The reply email may be destined to email address(es) in the “from” and/or “cc” fields of the generate email. The reply email includes a reply message provided by the non-registered user(s).

The reply email may be obtained by accessing the email account of the non-registered user that sent the reply email, and deleting the reply email from the email account of the non-registered user. Alternatively or additionally, the reply email may be obtained by accessing the email account of the registered user to which the reply email was sent, and deleting the reply email from the email account of the registered user.

At 320, the reply email may be uploaded to the interactive multi-user IM session. The reply message may be seamlessly integrated into the corresponding cluster, which may ensure all registered users can access and engage with the contents of the reply email.

The reply email may be uploaded to the conversation of the IM session, for viewing by the registered users participating in the IM session.

The reply email may be uploaded to correspond to the category (e.g., topic) of the generated email (that triggered the reply email). This may provide a smooth flow of conversation for each category (e.g., topic) of conversation. As described herein, multiple emails may be generated corresponding to multiple clusters, where each email may correspond to a single cluster such as by topic. The reply email may be uploaded to the corresponding cluster based on the category (e.g., topic) which may be in the “subject” field of the reply email.

The uploading may be done by synchronizing and/or distributing the reply message to the corresponding cluster provided to each of the registered users.

The uploading may be done by appending the reply email to the corresponding cluster-specific (e.g., topic-specific) threads.

At 322, features described with reference to 302-320 may be dynamically iterated during the conversation, as messages are posted and reply emails are received, for enabling dynamic interactions between the registered users participating in the IM session and the non-registered users that are not directly participating in the IM session but are indirectly participating via email.

Referring now back to FIG. 4, a sequence diagram is presented for enabling a conversation between a registered user A (RUA) 402 (i.e., the client terminal used by RUA), a registered user B (RUB) 404 (i.e., the client terminal used by RUB), and a non-registered user (NRU) 406 (i.e., the client terminal used by NRU), via IM messages managed by an IM server 408 and an email sever 410 (e.g., SMTP server) managing RUA’s email account 412 and NRU’s email account 414. The sequence diagram described with reference to FIG. 4 may be implemented by components of system 100 described with reference to FIG. 1, and be based on features of the method(s) described with reference to FIGS. 2A and/or 2B and/or 3.

At 416, a flow is described for embodiments in which IM server 408 has access to RUA’s email account 412.

At 418, RUA 402 initiates an IM message via IM server 408.

At 420, IM server 408 sends the IM message to RUB 404. The message delivery process ensures encryption and synchronization, preserving security and data integrity across endpoints.

At 422, RUA 402 sends the IM message posted to the IM server as an email message (i.e., SMTP message) to NRU 406 via RUA’s email account.

At 424, NRU 406 replies via NRU’s email account 414.

At 426, the reply email is received by RUA’s email account 412.

Now, once the reply email reaches RUA’s email account, alternative approaches for retrieving and deleting the reply email, and uploading the reply email to the IM server 408 are presented. The IM server seamlessly merges the reply email into the interactive multi-participant IM session of RUA and RUB.

At 428, a first flow is described for embodiments in which IM server 408 has IMAP access to RUA’s email account 412.

At 430, IM server 408 retrieves the reply message from RUA’s email account 412, and deletes the reply message from RUA’s email account 412.

At 432, IM server 408 uploads the reply email to RUA 402 as a conversation on the IM server 408.

At 434, RUA reads the reply from NRU, which is presented as an IM message rather than an email.

At 436, a second alternative flow is described for embodiments in which client code running on RUA’s client device has access to email server 410. The flow of 436 may be an alternative to flow 416.

438-446 are as described with reference to 418-426 of flow 416.

Alternatively to 428-434, at 448 the client code running on RUA’s client device 402 retrieves the reply message from RUA’s email account 412, and deletes the reply message from RUA’s email account 412.

At 450, the client code running on RUA’s client device 402 uploads the reply email to RUA 402 as a conversation on the IM server 408.

At 452, RUA reads the reply from NRU, which is presented as an IM message rather than an email.

Referring now back to FIG. 5, a sequence diagram is presented for enabling a conversation between a registered user A (RUA) 502 (i.e., the client terminal used by RUA), a registered user B (RUB) 504 (i.e., the client terminal used by RUB), a non-registered user C (NRUC) 506 that becomes a registered user C (RUC) 508 (i.e., the client terminal used by NRUC and RUC), and a non-registered user D (NRUD) 510 (i.e., the client terminal used by NRU), via IM messages managed by an IM server 512 and an email sever 514 (e.g., SMTP server) managing RUA’s email account 516, RUC’s email account 518, and NRUD’s email account 520. The sequence diagram described with reference to FIG. 5 may be implemented by components of system 100 described with reference to FIG. 1, and be based on features of the method(s) described with reference to FIGS. 2A and/or 2B and/or 3.

At 522, RUA 502 initiates a conversation block on IM server 512, by posting the conversation block to an interactive multi-user chat session.

At 524, IM server 512 may queue the message for distribution and/or categorization.

At 526, IM server 512 distributes the IM message directly to RUA 502.

At 528, IM server 512 distributes the IM message directly to RUB 504.

At 530, IM server 512 prepares an email from the IM message for NRUC 506. The email address of NRUC is placed in the TO field of the email, along with the email address of NRUD. IM server 512 provides the generated email to email server 515.

At 532, IM server 512 prepares an email from the IM message for NRUD 510. The email address of NRUD is placed in the TO field of the email, along with the email address of NRUC. IM server 512 provides the generated email to email server 514.

At 534, the email is sent by email server 514 to NRUC 506.

At 536, the email is sent by email server 514 to NRUD 510.

At 538, NRUC 506 registers and becomes RUC 508. The system described herein may automatically adapt user permissions and/or access levels, which may ensure a seamless transition from non-registered to registered status.

At 540, NRUD 510 sends a reply email via NRUD’s email account 520. The reply is directed to RUA 502 and NRUC 506 (which has already converted to RUC 508).

At 542, the reply email sent from NRUD’s email account 520 is received by RUA’s email account 516.

At 544, the reply email sent from NRUD’s email account 520 is received by RUC’s email account 518, since NRUC’s email address was the destination in the original reply email.

Different approaches are presented for handling the reply email sent NRUD to NRUC which has become RUC.

A first flow 546 in which the reply email sent by NRUD is handed by the IM server 512 is presented.

At 548, IM server 512 retrieves the reply email sent by NRUD to RUA from RUA’s email account 516, and deletes the reply email from RUA’s email account 516.

At 550, IM server 512 uploads the reply email sent by NRUD to the conversation posted to the interactive multi-user IM session, which is read by RUA 502.

Alternatively at 552, when client code running on RUA’s client terminal 502 has access to email server 514, client code running on RUA’s client terminal 502 accesses NRUD’s reply email from RUA’s email account 516.

At 554, RUA 502 uploads NRUD’s reply email to IM server 514 for inclusion within the conversation posted to the interactive multi-user IM session.

Another flow 556 in which newly registered RUC 508 checks and uploads NRUD’s reply email is now described.

At 558, newly registered RUC 508 retrieves the reply email sent by NRUD from RUC’s email account 518.

At 560, newly registered RUC 508 uploads the reply email sent by NRUD to IM server 514 for inclusion within the conversation posted to the interactive multi-user IM session. A check may be performed prior to the upload to determine whether the reply email sent by NRUD has already been posted to the interactive multi-user IM session.

At 562, a flow is described for the case when the reply email sent by NRUD has already been provided to IM server 514 for inclusion within the interactive multi-user IM session.

At 564, when the reply email sent by NRUD has already been provided to IM server 514, RUC a duplicate upload is not performed.

At 566, a flow for handling the reply email sent by NRUD is described.

At 568, the reply email sent by NRUD is synchronized and distributed to RUA 502 as a conversation block posted to the interactive multi-user IM session.

At 570, the reply email sent by NRUD is synchronized and distributed to RUB 504 as the conversation block posted to the interactive multi-user IM session.

At 572, the reply email sent by NRUD is synchronized and distributed to RUC 508 as the conversation block posted to the interactive multi-user IM session.

Referring now back to FIG. 6, a sequence diagram is presented for creating emails and/or threads based on clusters generated from a conversation in an interactive multi-user IM session between a registered user A (RUA) 602 (i.e., the client terminal used by RUA), a registered user B (RUB) 604 (i.e., the client terminal used by RUB), and a registered user C (RUC) 606 (i.e., the client terminal used by RUC), and a non-registered user (NRU) 608 (i.e., the client terminal used by NRU), via IM messages managed by an IM server 610, which are clustered by a machine learning model 612, and emails generated from clusters are managed by an email sever 614 (e.g., SMTP server) managing RUA’s email account 616. The sequence diagram described with reference to FIG. 6 may be implemented by components of system 100 described with reference to FIG. 1, and be based on features of the method(s) described with reference to FIG. 2A and/or FIG. 2B and/or FIG. 3.

At 618, RUA 602 initiates a conversation by an interactive multi-user IM session.

At 620, RUA 602 sends a conversation block to IM server 610.

At 622, the content of the conversation block and/or conversation is analyze by machine learning model 612 (e.g., by being fed into the machine learning model). The content of the conversation block and/or conversation is clustered, optionally by topic and/or category. Artificial intelligence tools may analyze user intent, sentiment, and/or priority to optimize message organization within clustered threads. Multi-modal clustering may integrates textual and/or visual embeddings, which may enable unified organization of messages containing text and/or images.

At 624, machine learning model 612 provides the clusters generated from the content of the conversation block and/or conversation, such as by assigning topic tags to the content and/or splitting the conversation block and/or conversation into threads.

At 626, IM server 610 delivers the conversation block and/or conversation in clusters and/or threads, such as topic-specific threads, to RUA 602.

At 628, IM server 610 delivers the conversation block and/or conversation in clusters and/or threads to RUB 604.

At 630, IM server 610 delivers the conversation block and/or conversation in clusters and/or threads to RUC 606.

At 632, one or more emails are created for the clusters, such as an email per cluster. The subject of the email may reflect the topic. The emails may be generated by IM server 610 and sent to email server 614.

At 634, the cluster specific email (e.g., topic specific email) is sent by email server 614 to NRU 608.

At 636, NRU 608 may respond in a reply email sent to RUA’s email account 616.

An exemplary flow 638 for managing NRU’s 608 reply email is now described. Two alternative flows are described, each flow based on a different approach for accessing RUA’s email account.

A first flow 640 in which access to RUA’s email account is performed by the IM server is now described.

At 642, IM server 610 retrieves the reply email from RUA’s email account 616. Once the reply email is retrieved, the reply email may be deleted from RUA’s email account 616, optionally by IM server 610.

At 644, IM server 610 uploads the reply email sent by NRU 608 to the corresponding thread (e.g., topic thread) on the IM server 610. The topic thread with the posted reply email is presented on a display of RUA 602.

At 646, IM server 610 synchronizes and distributes the reply email sent by NRU 608 to the corresponding topic thread, and presented on a display of RUB 604.

At 648, IM server 610 synchronizes and distributes the reply email sent by NRU 608 to the corresponding topic thread, and presented on a display of RUC 606.

A second flow 650 in which access to RUA’s email account is performed by client code running on RUA 602 is now described.

At 652, the client code running on RUA 602 retrieves the reply email from RUA’s email account 616. Once the reply email is retrieved, the reply email may be deleted from RUA’s email account 616, optionally by the client code running on RUA 602.

At 654, the reply email sent by NRU 608 is uploaded to the corresponding thread (e.g., topic thread) on the IM server 610.

At 656, IM server 610 synchronizes and distributes the reply email sent by NRU 608 and uploaded by RUA 602 to the corresponding topic thread, and presented on a display of RUB 604.

At 658, IM server 610 synchronizes and distributes the reply email sent by NRU 608 and uploaded by RUA 602 to the corresponding topic thread, and presented on a display of RUC 606.

Referring now back to FIG. 7, the example includes a message posted to an interactive multi-user IM session being converted to an email, for example, as described herein and/or with reference to FIG. 2A. The example also includes a scenario in which a non-registered user becomes a registered user, for example, as described herein and/or with reference to FIG. 2B.

Example portion 702 occurs between a registered user A (RUA) and a registered user B (RUB) by posting messages to an interactive multi-user IM session, prior to the non-registered user (NRU) becoming a registered user. For example, as described with reference to 202 of FIG. 2A.

Example portion 704 depicts an email sent to the NRU. The email is generated by converting the message posted to the interactive multi-user IM session to the email. For example, as described with reference to 204, 206, and/or 208 of FIG. 2A.

Example portion 706 depicts a reply email sent by the NRU in response to the email. For example, as described with reference to 212 of FIG. 2A.

Example portion 708 depicts an update to the interactive multi-user IM session by posting the reply email of the NRU to the interactive multi-user IM session. For example, as described with reference to 214 of FIG. 2A.

Example portion 710 depicts registration of the NRU to become a RU, which grants access to post to and/or read posts on the interactive multi-user IM session. For example, as described with reference to 250 of FIG. 2B.

Example portion 712 depicts the interactive multi-user IM session after the NRU has registered to become a RU which has been granted access to post to and/or read posts on the interactive multi-user IM session.

Referring now back to FIG. 8, the example of clustering of conversation blocks of a multi-user instant messaging session into clusters for generating an email(s) for the clusters for sending to non-registered users is provided, for example, as described herein and/or with reference to FIG. 3.

The example of FIG. 8 relates to a multi-user instant messaging session where a team of registered users (RUs) is discussing three distinct topics: Event Logistics, Budget Allocation, and Attendee Management. During the session, these topics are automatically identified, for example, as described with reference to 304 of FIG. 3. The conversation is automatically segmented into Conversation Blocks, by grouping related messages under each topic, for example, as described with reference to 304 of FIG. 3.

Example portion 802 depicts an example of the interactive multi-user IM session with the three distinct topics. For example, as described with reference to 302 of FIG. 3. The user interface dynamically updates to reflect clustered topics, enabling intuitive navigation and efficient interaction for registered and non-registered users.

Example portion 804 depicts an example of a respective email generated from a corresponding cluster created by clustering the messages of the interactive multi-user IM session. Three emails are generated corresponding to the three clusters based on three identified topics of the interactive multi-user IM session. The email(s) are sent to the NRU. For example, as described with reference to 304-312 of FIG. 3.

Example portion 806 depicts an example of the NRU replying to the email with a reply email. The reply email is integrated with the interactive multi-user IM session. For example, as described with reference to 318-320 of FIG. 3.

At least one embodiment described herein integrates advanced language translation and/or content moderation capabilities, which may enable seamless, secure, and/or culturally aware communication across diverse user groups. Language translation transcends basic text conversion by incorporating contextual adaptations, such as idiomatic expressions, cultural nuances, and analogies, which may ensure that the message retains its intended meaning and/or relevance in the recipient's preferred language. This adaptive approach may enhance the clarity and/or effectiveness of communication across linguistic and cultural boundaries.

At least one embodiment described herein incorporates robust content moderation features to ensure a respectful and/or secure communication environment. Utilizing state-of-the-art Natural Language Processing (NLP) models, at least one embodiment described herein performs sentiment analysis, toxicity detection, and/or profanity filtering to identify, block, and/or flag inappropriate, abusive, and/or harmful content in real-time. Content moderation may extend to dynamic adjustments, which may allow for automated redaction, replacement of offensive terms, and/or contextual rephrasing to align with established community guidelines. These combined features may not only enhance cross-cultural communication but may also maintain high standards of inclusivity, safety, and/or compliance within the messaging ecosystem.

At least one embodiment described herein dynamically adapts message formatting based on the recipient’s device and/or platform to ensure optimal readability and/or engagement. For mobile devices, the system described herein may condense content into shorter, more concise formats, while for desktop or augmented reality platforms, the system may enable the inclusion of detailed content, hyperlinks, and/or multimedia elements. This may ensure consistent communication quality, regardless of the user’s context or device capabilities.

At least one embodiment described herein incorporates context-aware personalization to tailor communication based on the recipient’s preferences, time zone, and/or geographic location. For example, suggesting meeting times adjusted to both parties' time zones and/or attach location-specific recommendations (e.g., local restaurants or weather updates).

In at least one embodiment, an intelligent prioritization engine may rank messages based on urgency, context, and/or user-defined preferences, while an integrated summarization tool may condense lengthy email threads and/or IM conversations into concise, actionable insights. Powered by advanced NLP processes, they may enable users to manage their communications more efficiently, reducing cognitive overload and/or enhancing productivity.

At least one embodiment described herein employs augmented moderation techniques that combine automated content filtering with user feedback loops. When messages are flagged for potential violations, users can provide feedback (e.g., approve, revise, or reject). This feedback may be integrated into machine learning models, which may enable continuous improvement in detecting and/or addressing inappropriate content while aligning with community standards.

At least one embodiment described herein may include multi-layered privacy controls that empower users to manage their communication securely. Features include message expiration timers for sensitive content, adjustable visibility settings for specific recipients, and/or adaptive encryption modes that toggle based on the context and sensitivity of the conversation. These privacy features may ensure compliance with data protection standards while maintaining user trust.

At least one embodiment described herein integrates sentiment-driven auto-reply capabilities that analyze the emotional tone of incoming messages and/or generate contextually appropriate responses. For instance, empathetic replies are generated for messages with a negative sentiment, while enthusiastic replies are crafted for positive messages. This feature may enhance conversational flow and/or may ensure emotionally intelligent communication.

At least one embodiment described herein includes a conversational analytics process that provides insights such as response rates, engagement levels, sentiment trends, and/or topic popularity. These analytics may help users and/or organizations evaluate and/or enhance their communication strategies, ensuring more effective and impactful exchanges.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant IM sessions will be developed and the scope of the term IM session is intended to include all such new technologies a priori.

As used herein the term “about” refers to ± 10 %.

The terms "comprises", "comprising", "includes", "including", “having” and their conjugates mean "including but not limited to". This term encompasses the terms "consisting of" and "consisting essentially of".

The phrase "consisting essentially of" means that the composition or method may include additional ingredients and/or steps, but only if the additional ingredients and/or steps do not materially alter the basic and novel characteristics of the claimed composition or method.

As used herein, the singular form "a", "an" and "the" include plural references unless the context clearly dictates otherwise. For example, the term "a compound" or "at least one compound" may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system for enabling message transmission between registered user registered posting on a multi-user instant messaging (IM) session and to non-registered users via email, comprising:
at least one processor of a server executing a code for:
receiving a message posted to an interactive multi-user IM session by a first registered user, the message destined for at least one recipient;
for each respective recipient, checking whether the respective recipient is a registered or non-registered;
in response to the respective recipient being non-registered, converting the message to an email, and sending the email to an email address of each respective recipient.

2. The system of claim 1, further comprising:
wherein the at least one recipient comprises at least one second registered user participating in the interactive multi-user IM session; and
sending the message to a respective client terminal of each of the at least one second registered user for posting to the interactive multi-user IM session presented on a display of the respective client terminal of the respective second registered user.

3. The system of claim 1,
wherein the email is sent to an email of a non-registered user;
wherein a reply email is sent by the non-registered user to the first registered user as a response to the email;
further comprising:
accessing the reply email from an email account of the first registered user; and
posting the reply email to the interactive multi-user IM session.

4. The system of claim 3, wherein the first registered user and at least one second registered user are participating in the interactive multi-user IM session, and the reply email when posted to the interactive multi-user IM session is synchronized between, and presented on, a display of a client terminal of each one of the first registered user and the at least one second registered user.

5. The system of claim 3, further comprising deleting the reply email from the email account of the first registered user after obtaining the reply email from the email account.

6. The system of claim 3, wherein the received reply email and the posting is one of: obtained by the at least one processor of the server from the email account of the first registered user and posted by the at least one processor of the server, and obtained by code running on a client terminal of the first registered user and posted to the interactive multi-user IM session by the code running on the client terminal of the registered user.

7. The system of claim 3, wherein the reply email is posted to the interactive multi-user IM session as a continuation to a conversation between a plurality of users including the first registered user and the first non-registered user.

8. The system of claim 3,
wherein the email is sent to an email account of a first non-registered user;
wherein a reply email is sent by the first non-registered user to the first registered user as a response to the email;
wherein the first non-registered user registers to become a second registered user participating in the interactive multi-user IM session, and
wherein the reply email is obtained from the email account of the first registered user;
posting the reply email to the interactive multi-user IM session to create an updated interactive multi-user IM session; and
presenting an updated interactive multi-user IM session including the posted message obtained from the reply email, on a display of a client terminal of the second registered user participating in the interactive multi-user IM session.

9. The system of claim 8, wherein the email is further sent to an email account of a second non-registered user;
wherein the second non-registered user sends a reply email to an email account of the first registered user and to the email account of the first non-registered user;
wherein the reply email is obtained from the email account of the first non-registered user that converted to become the second registered user by code running on a client terminal of the second registered user; and further comprising:
receiving the reply email from the client terminal of the second registered user; and
posting the reply email to the interactive multi-user IM session.

10. The system of claim 9, further comprising:
receiving a query from the client terminal of the second registered user checking whether the reply email has been previously posted to the interactive multi-user IM session from the email account of the first registered user, and
in response to an indication that the reply email has not been posted to the interactive multi-user IM session, receiving the reply email from the client terminal of the second registered user and posting the reply email to the interactive multi-user IM session.

11. The system of claim 10, further comprising:
in response to an indication that the reply email has been posted to the interactive multi-user IM session from the email account of the first registered user, ignoring the reply email from the client terminal of the second registered user, and presenting the interactive multi-user IM session with the posted reply email on the display of the client terminal of the second registered user.

12. The system of claim 8, wherein the second non-registered user registers to become the second registered user after the email is sent to the email address of the second non-registered user.

13. The system of claim 1, wherein the registered user is registered for sending messages to other registered users via the multi-user IM session, and a non-registered user is not registered for sending messages via the multi-user IM session.

14. A system for enabling message transmission between registered user registered posting on a multi-user instant messaging (IM) session and to non-registered users via email, comprising:
at least one processor of a server executing a code for:
accessing a conversation between a plurality of registered users interacting in an interactive multi-user IM session;
segmenting the conversation into a plurality of segmented conversation blocks;
analyzing each of the plurality of segmented conversation blocks;
according to the analysis, allocating each segmented conversation block of the plurality of segmented conversation blocks into cluster of a plurality of clusters;
generating at least one email, each email corresponding to each cluster, each email including an aggregation of the segmented conversation blocks allocated to the cluster; and
sending the at least one email to at least one non-registered user excluded from the interactive multi-user IM session.

15. The system of claim 14, wherein the analyzing and the allocating comprises:
dynamically clustering the segmented conversation blocks into the plurality of clusters using a transformer architecture and/or hybrid supervised-unsupervised processes.

16. The system of claim 14, wherein the analyzing comprising:
feeding each segmented conversation block of the plurality of segmented conversation blocks into a machine learning model;
obtaining a classification category of a plurality of classification categories for each segmented messages from the machine learning model;
allocating each segmented conversation block to a respective cluster corresponding to the classification category,
wherein the email is generated for each cluster.

17. The system of claim 14, wherein the analyzing comprises:
clustering the plurality of segmented conversation blocks into a plurality of clusters using a clustering machine learning model using a non-supervised approach.

18. The system of claim 14, wherein each cluster corresponds to a certain topic of a plurality of topics.

19. The system of claim 14, further comprising generating a conversation block for each cluster, and distributing a plurality of conversation blocks corresponding to the plurality of clusters to the plurality of registered users of the interactive multi-user IM session.

20. The system of claim 19, wherein the plurality of conversation blocks are distributed as cluster-specific threads.

21. The system of claim 14, wherein the at least one email includes a tag of the cluster in a subject field, and the plurality of registered users in the from and/or cc field.

22. The system of claim 14, further comprising:
receiving in response to the at least one email, a reply email from the at least one non-registered user;
uploading a reply message from the reply email to the corresponding cluster of the interactive multi-user IM session for viewing by the plurality of registered users, by synchronizing and distributing the reply message to the corresponding cluster provided to each of the plurality of registered users.

23. The system of claim 22, wherein receiving the reply email comprises accessing the reply email from an email account of the at least one non-registered user, and deleting the reply email from the email account of the at least one non-registered user.

24. The system of claim 23, wherein the receiving, the deleting, and the uploading, are performed by client code running on a device of a registered use of the plurality of registered users participating in the interactive multi-user IM session.
